(19) United States
(12) Patent Application Publication
(10) Pub. No.: US 2026/0139894 A1
(43) Pub. Date: May 21, 2026

(54) REFRIGERATOR AND HOME APPLIANCE

(71) Applicant: LG Electronics Inc., Seoul (KR)

(72) Inventors: Minho LEE, Seoul (KR); Younseok LEE, Seoul (KR); Sanggyun LEE, Seoul (KR); Yongwon DONG, Seoul (KR); Jaeun SHIN, Seoul (KR)

(21) Appl. No.: 19/394,390

(22) Filed: Nov. 19, 2025

(30) Foreign Application Priority Data
Nov. 20, 2024 (KR) 10-2024-0166172

(51) Int. Cl. F25D 23/06; E05D 7/00

(52) U.S. Cl. CPC F25D 23/062; E05D 7/00; F25D 2323/024

(57) ABSTRACT

A refrigerator includes a cabinet; a main door; a sub door rotatably connected to the main door; a main hinge device that allows the main door to rotate with respect to the cabinet; and a sub hinge device that allows the sub door to rotate relative to the main door. The main hinge device includes a hinge body installed at the cabinet, a pin unit provided at the hinge body or the main door, and a pin slot provided at the hinge body or the main door. The sub hinge device includes a hinge body coupled to the sub door, and a hinge pin extending from the hinge body and providing a rotation center of the sub door. During an opening process of the main door, relative positions of the pin slot and the pin unit vary, thereby allowing the rotation center of the main door to move.

### CROSS-REFERENCE TO RELATED APPLICATIONS

This application claims the benefit of Korean Patent Application No. 10-2024-0166172, filed on Nov. 20, 2024. The disclosure of the prior application is incorporated by reference in its entirety.

### BACKGROUND

The present disclosure relates to a refrigerator and a home appliance.

In general, a refrigerator is a home appliance for storing foods in an internal storage space, which is shield by a door, at a low temperature by low temperature air. For this, the refrigerator is configured to accommodate the food in an optimum state by cooling the internal storage space using cold air generated through heat exchange with a refrigerant circulating in a refrigeration cycle.

The refrigerator may be independently placed in a kitchen or living room or may be accommodated in a space defined by a furniture cabinet of the kitchen.

The refrigerator may include a cabinet having a storage space and a door connected to the cabinet to open and close the storage space.

For example, if the refrigerator is installed inside the furniture cabinet, there is a risk that the door may hit the furniture cabinet during an opening process, which may limit an opening angle of the door.

Recently, a hinge structure has been developed to prevent the door from interfering with surrounding structures such as a furniture cabinet during a door opening process.

There is a prior art document of International Publication No. WO2019/007278A1.

However, the prior art document only discloses a hinge structure of a single door, and does not disclose a hinge structure in a case where the door is composed of a first door and a second door rotatable with respect to the first door.

### SUMMARY

One embodiment provides a refrigerator and a home appliance in which an opening angle of the main door increases when the door includes a main door and a sub door.

Alternatively or additionally, one embodiment provides a refrigerator and a home appliance in which interference with surrounding structures is prevented during an opening process of the main door.

Alternatively or additionally, one embodiment provides a refrigerator and a home appliance in which interference with the main door and surrounding structures is prevented during an opening process of the sub door.

A refrigerator according to one aspect may include: a cabinet to form a storage space; a main door that opens and closes the storage space; a sub door received in a receiving portion of the main door and rotatably connected to the main door; a main hinge device that allows the main door to rotate with respect to the cabinet; and a sub hinge device that allows the sub door to rotate with respect to the main door.

The main hinge device may include a hinge body installed at the cabinet, a pin unit provided at one of the hinge body and the main door, and a pin slot provided at another of the hinge body and the main door and in which the pin unit is received.

The sub hinge device may include a hinge body coupled to the sub door, and a hinge pin extending from the hinge body and providing a rotation center of the sub door.

During an opening process of the main door, relative positions of the pin slot and the pin unit may be varied, thereby allowing the rotation center of the main door to move.

The pin unit may include a first pin and a second pin. A distance between a portion of the hinge pin and a front surface of the main door may be less than a distance between the first pin and the front surface of the main door.

A distance between a portion of the hinge pin and a front surface of the main door may be less than a distance between the second pin and the front surface of the main door.

Center lines of the hinge pin and each of the first pin and the second pin may be spaced apart from each other in a horizontal direction.

The pin slot may include a first end in contact with or adjacent to the first pin when the main door is closed, and a second end in contact with or adjacent to the second pin when the main door is opened by a maximum opening angle.

When the main door is closed, a distance between a portion of the hinge pin and a front surface of the main door may be less than a distance between the first end and the front surface of the main door.

When the main door is closed, a distance between a portion of the hinge pin and the front surface of the main door may be less than a distance between the second end and the front surface of the main door.

When a side surface adjacent to the main hinge device among both side surfaces of the main door is referred to as a first side surface, a distance between a portion of the hinge pin and the first side surface may be less than a distance between the first end and the first side surface.

When the main door is closed, a distance between the second end and the first side surface may be less than a distance between a portion of the hinge pin and the first side surface.

The pin unit may include a first pin and a second pin. The pin slot may include a first slot for receiving the first pin and a second slot for receiving the second pin.

When the main door is closed, at least a portion of the hinge pin may be positioned closer to the front surface of the main door than the first slot or the second slot.

When a side surface adjacent to the main hinge device among both side surfaces of the main door is referred to as a first side surface, when the main door is closed, at least a portion of the first slot may be positioned closer to the first side surface than the hinge pin, or at least a portion of the second slot may be positioned closer to the first side surface than the hinge pin.

When the main door and sub door are closed, at least a portion of the pin slot may overlap the sub door in a vertical direction.

The pin unit may include a first pin and a second pin received in the pin slot. The pin slot may include a first end in contact with or adjacent to the first pin when the main door is closed, and a second end in contact with or adjacent to the second pin when the main door is opened by a maximum opening angle, and the first end may overlap the sub door in a vertical direction.

The second end may not overlap the sub door in a vertical direction.

When the main door and sub door are closed, a portion of the pin slot may be positioned farther from a front surface of the main door than the sub door.

The first pin may overlap the sub door in a vertical direction.

The second pin may overlap or not overlap the sub door in a vertical direction.

The main door may include a receiving portion that forms a space for receiving the sub hinge device, and the receiving portion may be provided with a pin coupling portion to which the hinge pin is coupled.

According to another aspect, a refrigerator comprises a cabinet to form a storage space; a main door that opens and closes the storage space; a sub door received in a receiving portion of the main door and rotatably connected to the main door; a main hinge device that allows the main door to rotate with respect to the cabinet; and a sub hinge device that allows the sub door to rotate with respect to the main door. The main hinge device includes a hinge body installed at the cabinet, a pin unit provided at one of the hinge body and the main door and having a first pin and a second pin, and a pin slot provided at another of the hinge body and the main door and receiving the pin unit. The sub hinge device may include a hinge body coupled to the sub door, and a hinge pin extending from the hinge body and providing a rotation center of the sub door.

A centerline of the first pin, a centerline of the second pin, and a centerline of the hinge pin may be spaced apart from each other. For example, the centerline of the first pin, the centerline of the second pin, and the centerline of the hinge pin may be spaced apart from each other in a horizontal direction.

At least a portion of the hinge pin may be positioned closer to a front surface of the main door than the first pin and the second pin.

When a side surface adjacent to the main hinge device among both side surfaces of the main door is referred to as a first side surface, at least a portion of the hinge pin may be positioned closer to the first side surface than at least one of the first pin or the second pin.

At least a portion of the hinge pin may be positioned closer to a front surface of the main door than the pin slot.

When a side surface adjacent to the main hinge device among both side surfaces of the main door is referred to as a first side surface, at least a portion of the pin slot may be positioned closer to the first side surface than the hinge pin.

The description of the refrigerator described above can be applied to a home appliance as well. For example, the home appliance may include: a cabinet to form a storage space; a main door that opens and closes the storage space; a sub door received in a receiving portion of the main door and rotatably connected to the main door; a main hinge device that allows the main door to rotate with respect to the cabinet; and a sub hinge device that allows the sub door to rotate with respect to the main door. The main hinge device may include a hinge body installed at the cabinet, a pin unit provided at one of the hinge body and the main door, and a pin slot provided at another of the hinge body and the main door and in which the pin unit is received. The sub hinge device may include a hinge body coupled to the sub door, and a hinge pin extending from the hinge body and providing a rotation center of the sub door. During an opening process of the main door, relative positions of the pin slot and the pin unit may be varied, thereby allowing the rotation center of the main door to move.

The configuration described above for a refrigerator can be applied equally to a home appliance.

According to one embodiment, a main door opens as a rotation center of the main door moves, thereby providing an advantage in that an opening angle of the main door increases.

According to one embodiment, a rotation center of the main door can be moved away from one surface of a furniture cabinet, so that the main door can be prevented from interfering with surrounding structures during an opening process of the main door.

According to one embodiment, interference with the main door and surrounding structures can be prevented during an opening process of a sub door.

### BRIEF DESCRIPTION OF THE DRAWINGS

FIG. 1 is a drawing showing a refrigerator received in a furniture cabinet according to a first embodiment.

FIG. 2 is a perspective view of a refrigerator according to a first embodiment.

FIG. 3 is a perspective view of a first door according to a first embodiment.

FIG. 4 is an exploded perspective view of an upper main hinge device and a lower main hinge device according to a first embodiment.

FIG. 5 is a plan view showing a state in which an upper main hinge device is connected to a first door according to a first embodiment.

FIG. 6 is a bottom view showing a state in which a lower main hinge device is connected to a first door according to a first embodiment.

FIG. 7 is a cross-sectional view taken along line 7-7 of FIG. 3.

FIG. 8 is a cross-sectional view taken along line 8-8 of FIG. 3.

FIG. 9 is a perspective view of a sub door according to a first embodiment.

FIG. 10 is a drawing showing a state in which an upper sub hinge device is coupled to a sub door according to a first embodiment.

FIG. 11 is a cross-sectional view taken along line 11-11 of FIG. 3.

FIG. 12 is a drawing showing a state in which a lower sub hinge device is coupled to a sub door according to a first embodiment.

FIG. 13 is a cross-sectional view taken along line 13-13 of FIG. 3.

FIG. 14A is a drawing showing a state in which a main door and a sub door are closed.

FIG. 14B is a drawing showing a state in which a main door is opened by a first angle.

FIG. 15A is a drawing showing a state in which a main door is opened by a second angle greater than a first angle.

FIG. 15B is a drawing showing a state in which a main door is opened by a third angle greater than a second angle.

FIG. 15C is a drawing showing a state in which a main door is opened by a maximum opening angle.

FIGS. 16A to 19B illustrate a rotation of a sub door in a state in which a main door is closed.

FIG. 20 is a plan view showing a first door according to a second embodiment.

FIG. 21 is a view showing a state in which a main door is opened by a maximum opening angle according to a second embodiment.

FIG. 22 is a perspective view showing a main hinge device according to a third embodiment.

### DETAILED DESCRIPTION

Hereinafter, some embodiments of the present disclosure will be described in detail with reference to the accompanying drawings. It should be noted that when components in the drawings are designated by reference numerals, the same components have the same reference numerals as far as possible even though the components are illustrated in different drawings. Further, in description of embodiments of the present disclosure, when it is determined that detailed descriptions of well-known configurations or functions disturb understanding of the embodiments of the present disclosure, the detailed descriptions will be omitted.

Also, in the description of the embodiments of the present disclosure, the terms such as first, second, A, B, (a) and (b) may be used. Each of the terms is merely used to distinguish the corresponding component from other components, and does not delimit an essence, an order or a sequence of the corresponding component. It should be understood that when one component is “connected”, “coupled” or “joined” to another component, the former may be directly connected, coupled or jointed to the latter or may be “connected”, coupled” or “joined” to the latter with a third component interposed therebetween.

In this specification, a front surface of a main door is a surface forming a front appearance of the main door, and a rear surface of the main door is a surface facing a cabinet or a storage space.

Hereinafter, a refrigerator will be described as an example of a home appliance. It should be noted that all components of the refrigerator described below, including those related to the door that opens and closes the space, can be applied equally to a home appliance other than refrigerator.

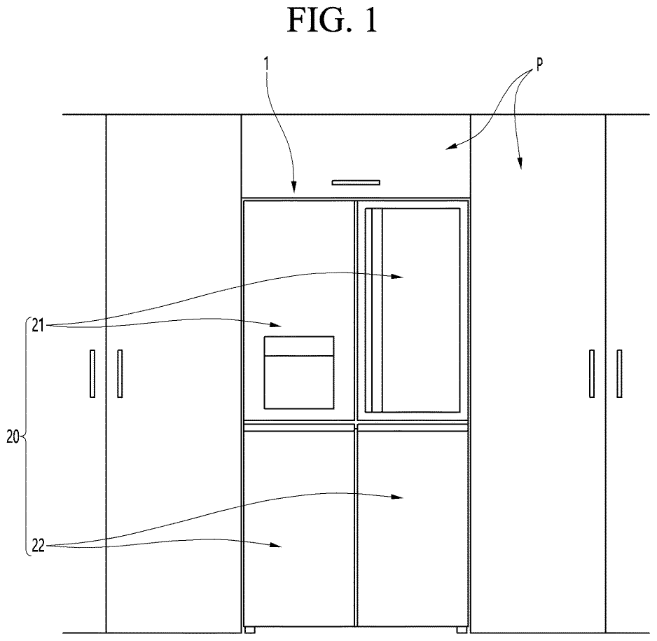

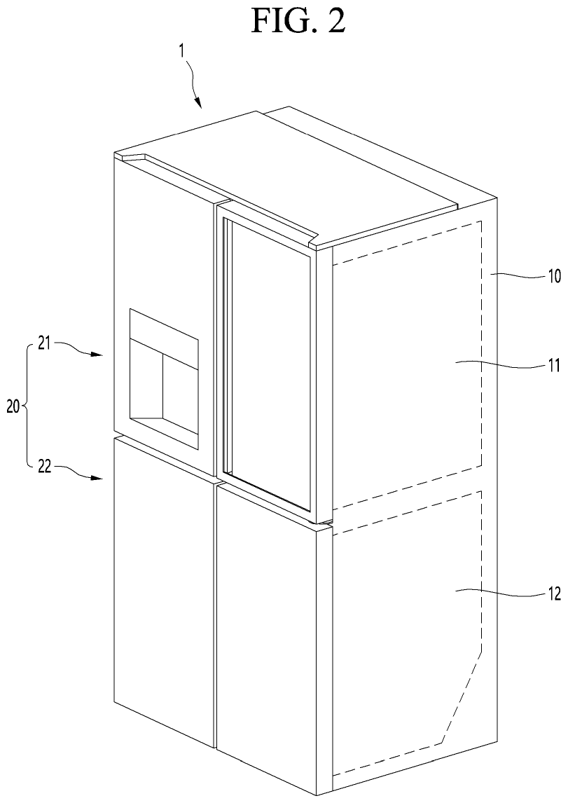

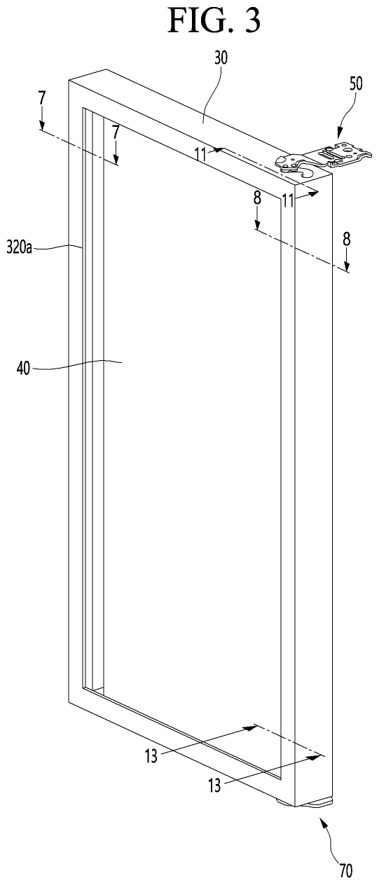

FIG. 1 is a drawing showing a refrigerator received in a furniture cabinet according to a first embodiment. FIG. 2 is a perspective view of a refrigerator according to a first embodiment. FIG. 3 is a perspective view of a first door according to a first embodiment.

Referring to FIGS. 1 to 3, a refrigerator 1 according to the present embodiment may be independently installed at a kitchen or accommodated within an indoor furniture cabinet (hereinafter collectively referred to as a “furniture cabinet”). When the refrigerator 1 is installed within an indoor furniture cabinet, a refrigerator 1 may be installed independently or arranged left and right with another refrigerator.

The refrigerator 1 may include a cabinet 10 having a storage space. The refrigerator 1 may further include a door 20 that opens and closes the storage space.

The storage space may be divided into, but is not limited to, a first space at an upper side and a second space at a lower side. The door 20 may also include a first door 21 than opens and closes the first space and a second door 22 that opens and closes the second space.

The first space may be a refrigerating chamber and the second space may be a freezing chamber, or vice versa. Alternatively, the storage space may include a first space and a second space divided left and right. Alternatively, the storage space may be a single space, and a single door may open and close the storage space.

At least one of the first door 21 or the second door 22 may be a rotary door. Alternatively, a single door 20 may be a rotary door.

Hereinafter, a rotary type door 20 will be described, with the first door 21 as an example.

Hereinafter, an example of opening and closing the first space 11 with multiple first doors 21 arranged left and right will be described.

At least one of a plurality of first doors 21 may include a main door 30 and a sub door 40 rotatable with respect to the main door 30.

The main door 30 may open and close the first space 11. The main door 30 may include an opening.

In a state in which the main door 30 is closed, the opening may be communicated with the first space 21.

The sub door 40 may form a portion of a front exterior of the first door 21. The sub door 40 may open and close the opening of the main door 30.

The main door 30 may include a receiving portion 320a in which the sub door 40 is received. The receiving portion 320a may be formed by a portion of a front surface of the main door 30 being recessed rearward. Accordingly, a left-right width of the sub door 40 may be less than a left-right width of the main door 30. The vertical length of the sub door 40 may be less than a vertical length of the main door 30.

When the main door 30 rotates, the sub door 40 may rotate together with the main door 30.

The main door 30 may be rotatably connected to the cabinet 10 by a main hinge device 50 and 70.

The sub door 40 may be rotatably connected to the main door 30 by a sub hinge device 60 and 80 to be described later.

The main hinge device 50 and 70 may include an upper main hinge device 50 and a lower main hinge device 70.

The upper main hinge device 50 may be connected to an upper side of the main door 30. The lower main hinge device 70 may be connected to a lower side of the main door 30.

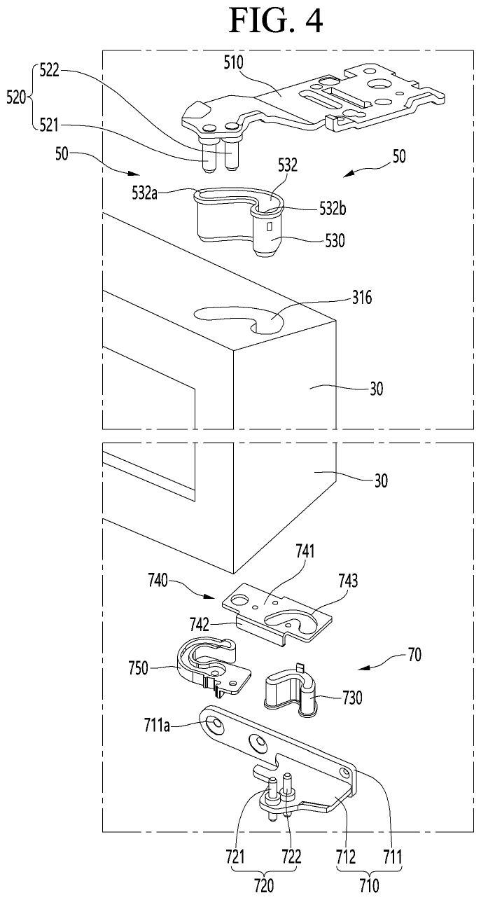

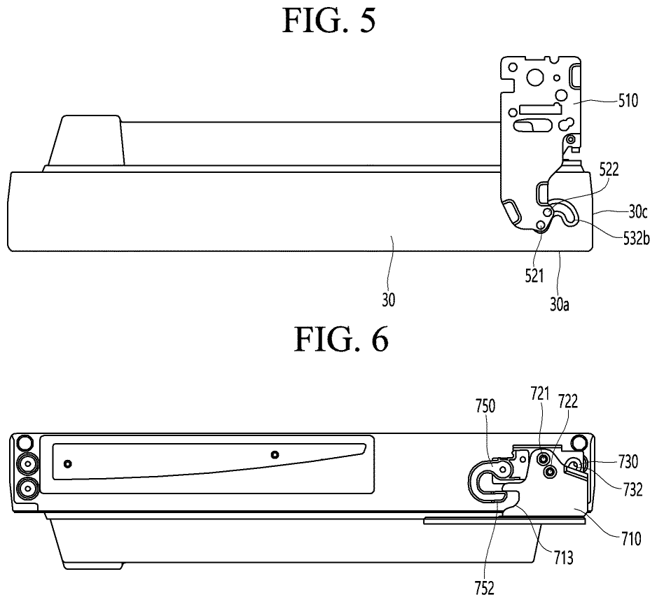

FIG. 4 is an exploded perspective view of an upper main hinge device and a lower main hinge device according to a first embodiment. FIG. 5 is a plan view showing a state in which an upper main hinge device is connected to a first door according to a first embodiment. FIG. 6 is a bottom view showing a state in which a lower main hinge device is connected to a first door according to a first embodiment.

Referring to FIGS. 4 to 6, a structure (at least a pin unit and a pin slot) for rotation of a main door 30 in an upper main hinge device 50 and a lower main hinge device 70 of the present embodiment can be formed symmetrically up and down.

The upper main hinge device 50 of the present embodiment may include a first hinge body 510. The first hinge body 510 may be coupled to an upper surface or a front surface of the cabinet 10. A portion of the first hinge body 510 may overlap an upper side of the main door 30 in a vertical direction. A portion of the first hinge body 510 may overlap an upper side of the sub door 40 in a vertical direction.

The upper main hinge device 50 may further include a first pin unit 520.

The first pin unit 520 may be formed integrally with the first hinge body 510 or may be coupled to the first hinge body 510.

The first pin unit 520 may include a first pin 521 and a second pin 522. The first pin 521 and the second pin 522 may be spaced apart from each other in the first hinge body 510.

The first pin 521 and the second pin 522 may extend from the first hinge body 510 toward the first door 21, for example. The first pin 521 and the second pin 522 may extend downward from the first hinge body 510.

As another example, the first pin 521 and the second pin 522 may be connected by a connecting member. In this case, it may also be understood that the first pin unit 520 includes a single pin. The single pin may be formed in a non-circular shape, but the first pin unit 520 may include a curved surface so as not to interfere with a wall forming a first pin slot 532, which will be described later, during an opening process of the first door 21. A curvature of at least a portion of the curved surface may be identical to a curvature of the first pin slot 532.

The upper main hinge device 50 may further include a first guide member 530.

The first guide member 530 may include a first pin slot 532 in which the first pin unit 520 is received.

The first guide member 530 may be coupled to the main door 30. A groove 316a in which the first guide member 530 is received may be formed in the main door 30.

Alternatively, the first guide member 530 may be omitted, and the groove 316 may serve as a first pin slot 532. In this case, one wall of the main door 30 may form the first pin slot 532.

When the sub door 40 is closed, at least a portion of the first pin slot 532 may overlap the sub door 40 in a vertical direction.

The first pin slot 532 (or the first guide member 530) may include a first end 532a and a second end 532b positioned opposite the first end 532a.

In a state in which the main door 30 is closed, the first pin 521 may be in contact with or be adjacent to the first end 532a. In a state in which the main door 30 is opened by a maximum opening angle, the second pin 522 may be in contact with or be adjacent to the second end 532b.

The first end 532a may be positioned closer to a front surface 30a of the main door 40 than the second end 532b.

Among both side surfaces of the main door 40, a side surface adjacent to an upper main hinge device 50 may be referred to as a first side surface 30c.

The second end 532b may be positioned closer to the first side surface 30c than the first end 532a.

When the sub door 40 is closed, the first end 532a may overlap the sub door 40 in a vertical direction.

When the sub door 40 is closed, the second end 532b may not overlap the sub door 40 in the vertical direction.

When the sub door 40 is closed, a portion of the first pin slot 532 may be positioned father from the front surface 30a of the main door 30 than the sub door 40.

The lower main hinge device 70 may include a second hinge body 710, a second pin unit 720, and a second guide member 730 having a second pin slot 732.

The second pin unit 720 may include a first pin 721 (or a third pin) and a second pin 722 (or a fourth pin) that are spaced apart from each other.

The first pin 721 of the second pin unit 720 may be aligned with the first pin 521 of the first pin unit 520 in a vertical direction. The second pin 722 of the second pin unit 720 may be aligned with the second pin 522 of the first pin unit 520 in a vertical direction.

Since the second pin unit 720 and the second guide member 730 are formed symmetrically with the first pin unit 520 and the first guide member 530 of the upper main hinge device 50, so a detailed description thereof will be omitted.

The second hinge body 710 may be coupled to the front surface of the cabinet 10. A portion of the second hinge body 710 may overlap a lower side of the main door 30 in a vertical direction.

The second hinge body 710 may include, for example, a coupling portion 711 coupled to the cabinet 10 and an extension 712 extending from the coupling portion 711.

The coupling portion 711 may be coupled to, for example, the front surface of the cabinet 10. One or more coupling holes 711a to which a coupling member is coupled may be formed at the coupling portion 711.

The first pin 721 and the second pin 722 may extend from the second hinge body 710 toward the main door 30, for example. The first pin 721 and the second pin 722 may extend upward from the second hinge body 710. For example, the second pin unit 720 may be provided at the extension 712.

The refrigerator 1 may further include a stopping member 740. The stopping member 740 may limit a rotation of the main door 30 when the main door 30 is opened by a maximum opening angle.

The stopping member 740 may be installed, for example, at a lower side of the main door 30. The stopping member 740 may include a plate 741 that is coupled to the main door 30.

The stopping member 740 may further include a stopper 742 that is bent from the plate 741. The stopper 742 may extend in an up-and-down direction. When the stopper 742 is in contact with a point of the extension 712 of the second hinge body 710 during an opening process of the main door 30, an opening of the main door 30 may be restricted.

The refrigerator 1 may further include a closing member 750 that provides closing force to the main door 30 during a closing process of the main door 30. Of course, the closing member 750 may be omitted.

The closing member 750 may be installed at a lower surface of the main door 30. When the main door 30 is opened and then rotated below a set angle during a closing process, an end 752 of the closing member 750 may be elastically deformed by contacting the second hinge body 710, thereby reducing a closing speed of the main door 30. When the main door 30 is rotated further below the set angle, the end 752 of the closing member 750 is elastically restored by being inserted into the groove 713 formed in the second hinge body 710, thereby providing elastic force so that the main door 30 can be completely closed. Of course, the above closing member 750 is not limited to the above structure, and may have various structures that allow the main door 30 to close at a set angle or less.

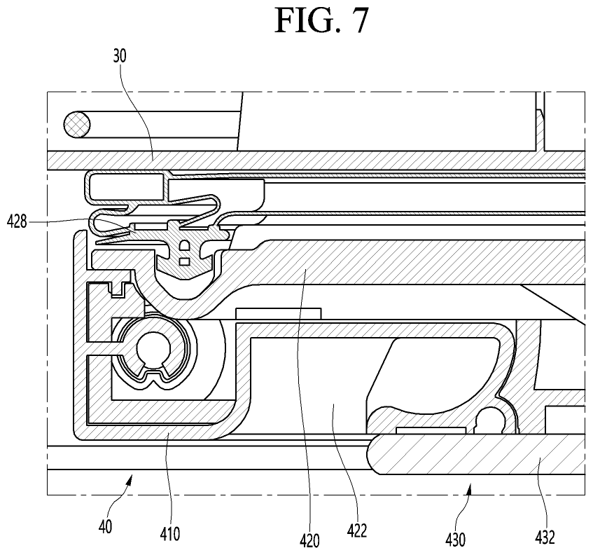

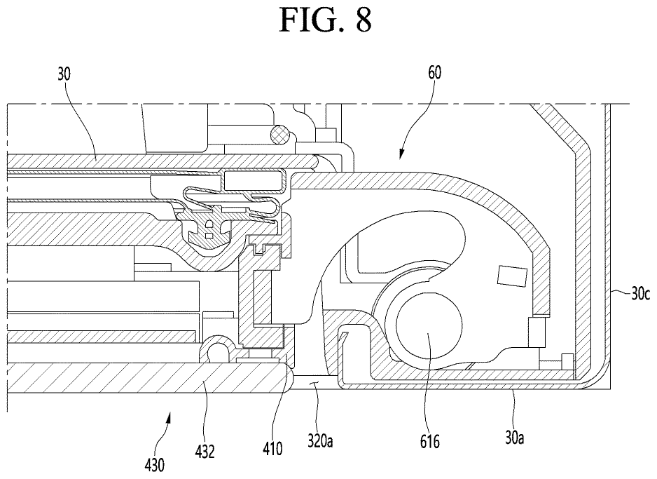

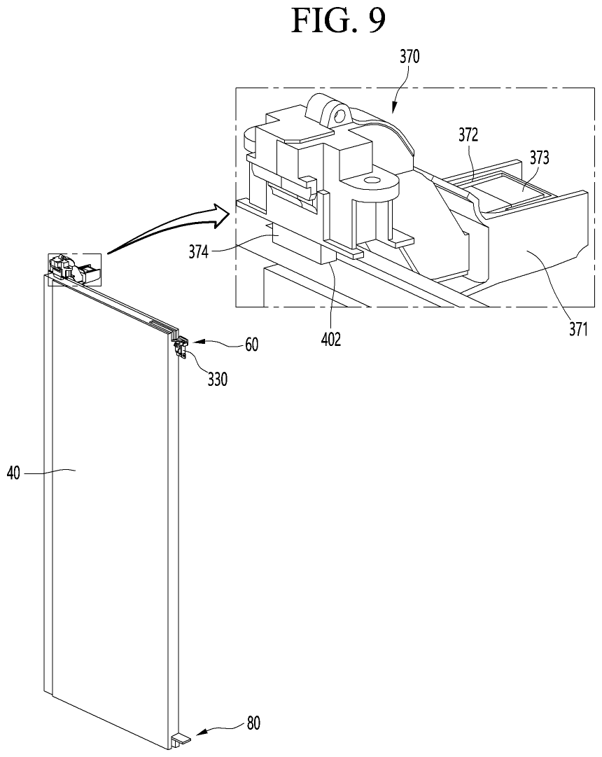

FIG. 7 is a cross-sectional view taken along line 7-7 of FIG. 3. FIG. 8 is a cross-sectional view taken along line 8-8 of FIG. 3. FIG. 9 is a perspective view of a sub door according to a first embodiment.

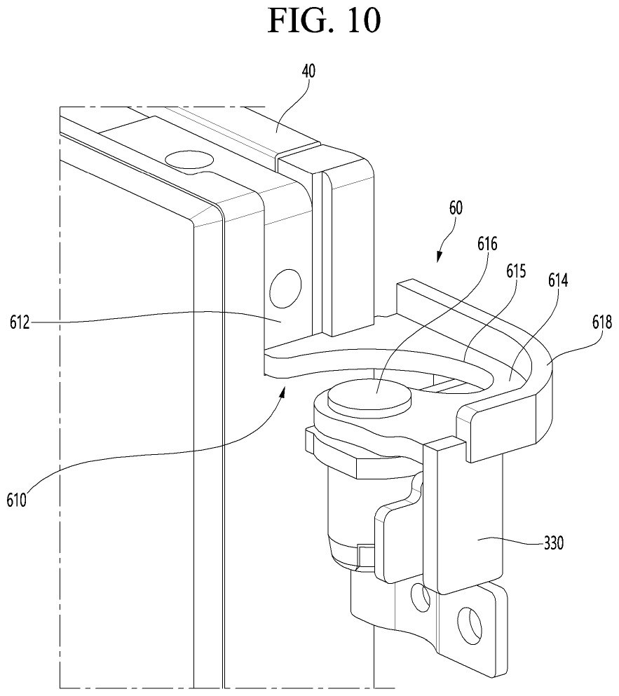

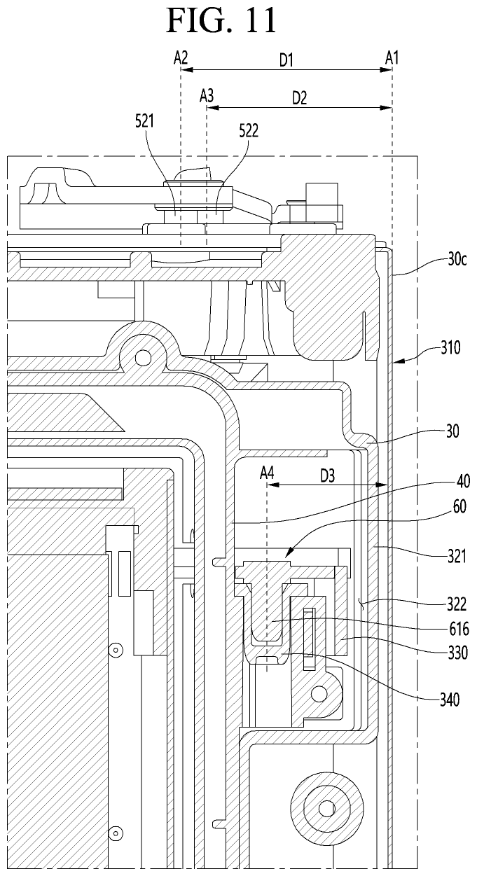

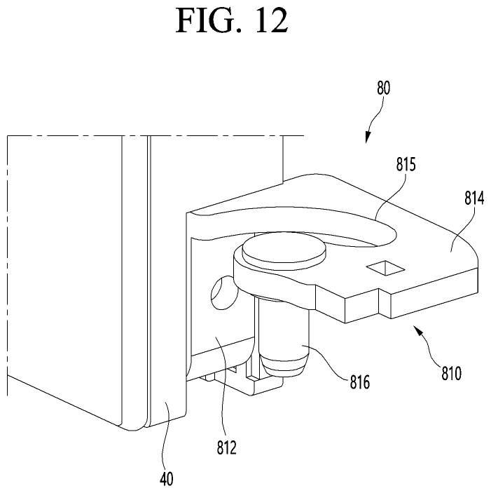

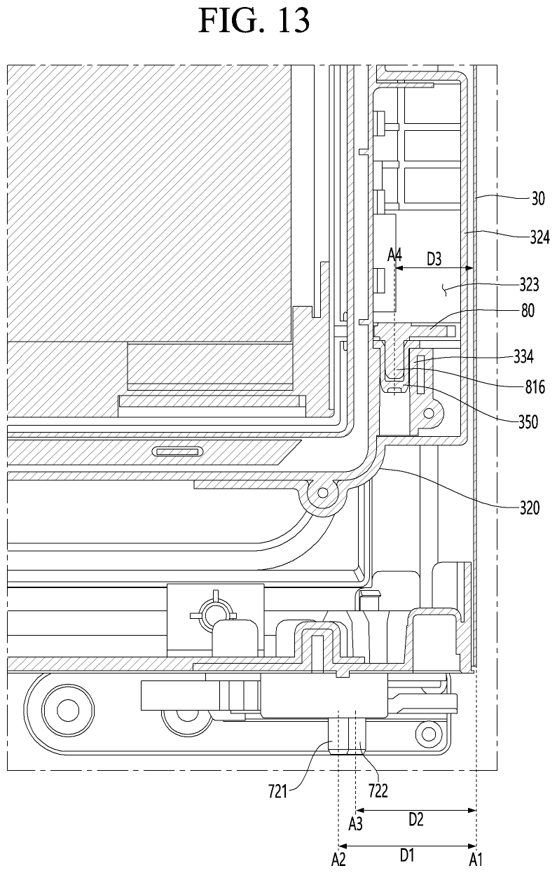

FIG. 10 is a drawing showing a state in which an upper sub hinge device is coupled to a sub door according to a first embodiment. FIG. 11 is a cross-sectional view taken along line 11-11 of FIG. 3. FIG. 12 is a drawing showing a state in which a lower sub hinge device is coupled to a sub door according to a first embodiment. FIG. 13 is a cross-sectional view taken along line 13-13 of FIG. 3.

Referring to FIGS. 7 to 13, the main door 30 may include an outer frame 310 and an inner frame 320. The inner frame 320 may include a receiving portion 320a for receiving the sub door 40.

The sub door 40 may include a door frame 410, a door liner 420 coupled to the door frame 410, and a panel assembly 430 coupled to the door frame 410 and the door liner 420. A gasket 428 may be coupled to the door liner 420. When the sub door 30 is closed, the gasket 428 may be in contact with the inner frame 320.

The panel assembly 430 may include a front panel 432. The front panel may be formed of a material that allows light to pass through. The door frame 410 may form a handle 422. For example, a portion of the door frame 410 may be a recessed space that provides a handle 422. A portion where the handle 422 is formed may be positioned at a rear side of the front panel 432. The panel assembly 430 may further include one or more insulating panels positioned at a rear side of the front panel 432.

The main door 30 and the sub door may be a locked stated or an unlocked state by a locking device 370.

When the main door 30 and the sub door 40 are in a locked state, the main door 30 and the sub door 40 may rotate together. When the main door 30 and the sub door 40 are in a unlocked state, the sub door 40 may be rotated relative to the main door.

In the present embodiment, the locking device 370 may cause the main door 30 and the sub door 40 to be in an unlocked state when the main door 30 is closed, and cause the main door 30 and the sub door 40 to be in a locked state when the main door 30 is opened.

Although not limited, the cabinet 10 may be provided with a magnetic body (not shown). The locking device 370 may be installed at the main door 30. The locking device 370 may interact with the magnetic body of the cabinet 10.

The locking device 370 may include a housing 371 and a movable member 372 that is rotatably installed in the housing 371 by a rotational axis and may be rotated in one direction by attraction with the magnetic body and may be rotated in another direction when the attraction with the magnetic body is removed. The locking device 370 may include a locking member 374 that is rotatably connected to the movable member 372 and is received in a locking groove 402 of the sub door 40 by passing through the main door 30 when the movable member 370 rotates in the other direction.

The sub hinge device 60, 80 may be positioned adjacent to a first side surface among both side surfaces of the sub door 40. The locking groove 402 may be positioned adjacent to a second side surface positioned opposite the first side surface among both side surfaces of the sub door 40.

For example, the locking groove 402 may be positioned adjacent to the second side surface at an upper surface of the sub door 40.

The sub hinge devices 60 and 80 of the present embodiment may include an upper sub hinge device 60 and a lower sub hinge device 80.

The upper sub hinge device 60 may be coupled to an upper portion of the door frame 410. The lower sub hinge device 80 may be coupled to a lower portion of the door frame 410.

The upper sub hinge device 60 may include a first hinge body 610 and a first hinge pin 616 extending from the first hinge body 610.

The first hinge body 610 may include a first mounting portion 612 installed at the sub door 40 and a first coupling portion 614 connected to the main door 30.

The first mounting portion 612 may be coupled to at least one of a side surface or an upper surface of the door frame 410. That is, the first mounting portion 612 may include a vertical portion, a horizontal portion, or a vertical portion and a horizontal portion.

The first coupling portion 614 may extend from an end of the first mounting portion 612. The first coupling portion 614 may be formed in a shape that is bent in one direction, and the first hinge pin 616 may be provided at the extended end.

The first hinge pin 616 may be coupled to the first coupling portion 614 or formed integrally with the first coupling portion 614.

The first hinge pin 616 may extend downward from the first coupling portion 614.

A cut portion 615 may be formed at the first coupling portion 614 so that at least a portion of the first coupling portion 614 is formed in a shape that is laterally bent.

The cut portion 615 can prevent interference between the first coupling portion 614 and the main door 30 while the sub door 40 rotates.

The first coupling portion 614 may be provided with an extension 618 for reinforcing strength. The extension 618 may extend from an edge of the first coupling portion 614 in a direction parallel to an extension direction of the first hinge pin 616.

Referring to FIG. 11, the main door 30 may include a first receiving portion 321 that forms a space 322 for receiving the upper sub hinge device 60. The first receiving portion 321 may be formed by recessing one surface of the inner frame 320.

The first receiving portion 321 may receive the first coupling portion 614. The first receiving portion 321 may be provided with a first pin coupling portion 330 to which a first hinge pin 616 is coupled.

The first hinge pin 616 may be inserted into the first pin coupling portion 330. The first hinge pin 616 may be directly coupled to the first pin coupling portion 330. Alternatively, a bushing 340 may be coupled to the first pin coupling portion 330, and the first hinge pin 616 may be coupled to the bushing 340.

Referring to FIG. 12, the lower sub hinge device 80 may include a second hinge body 810 and a second hinge pin 816 extending from the second hinge body 810.

The second hinge body 810 may include a second mounting portion 812 installed at the sub door 40 and a second coupling portion 814 connected to the main door 30.

The second mounting portion 812 may be coupled to at least one of a side surface or a bottom surface of the door frame 410. That is, the second mounting portion 812 may include a vertical portion, a horizontal portion, or a vertical portion and a horizontal portion.

The second coupling portion 814 may extend from an end of the second mounting portion 812. The second coupling portion 814 may be formed in a shape that is bent in one direction, and the second hinge pin 816 may be provided at the extended end.

The second hinge pin 816 may be coupled to the second coupling portion 814 or formed integrally with the second coupling portion 814.

The second hinge pin 816 may extend downward from the second coupling portion 814.

A cut portion 815 may be formed at the second coupling portion 814 so that at least a portion of the second coupling portion 814 is formed in a shape that is laterally bent.

The cut portion 815 can prevent interference between the second coupling portion 814 and the main door 30 while the sub door 40 rotates.

Referring to FIG. 13, the main door 30 may include a second receiving portion 324 that forms a space 323 for receiving the lower sub hinge device 80. The second receiving portion 324 may be formed by recessing one surface of the inner frame 320.

The second receiving portion 324 may receive the second coupling portion 814. The second receiving portion 324 may be provided with a second shaft coupling portion 334 to which the second hinge pin 816 is coupled.

The second hinge pin 816 may be inserted into the second pin coupling portion 334. The second hinge pin 816 may be directly coupled to the second pin coupling portion 334. Alternatively, a bushing 350 may be coupled to the second pin coupling portion 340, and the second hinge pin 816 can be coupled to the bushing 350.

Meanwhile, a horizontal distance D3 between a center line A4 of the hinge pin 616, 816 and a first side surface 30c (or an extension line A1 extending from the first side surface 30c) may be less than a horizontal distance D1 between a center line A2 of the first pins 521, 721 and the first side surface 30c (or the extension line A1).

A center line A4 of the hinge pin 616, 816 may be spaced apart from the center line A2 of the first pin 521, 721 and the center line A3 of the second pin 522, 722, for example, in a horizontal direction.

A horizontal distance D3 between the center line A4 of the hinge pin 616, 816 and the first side surface 30c (or the extension line A1 extending from the first side surface 30c) may be less than a horizontal distance D2 between the center line A3 of the second pin 522, 722 and the first side surface 30c (or the extension line A1).

When the sub door 40 is closed, at least a portion of the first pins 521 and 721 may overlap the sub door 40 in the vertical direction.

When the sub door 40 is closed, at least a portion of the second pins 522, 722 may overlap the sub door 40 in the vertical direction. Of course, depending on a variation of a diameter of the second pins 522, 722 or a relative position with respect to the first pins 521, 721, it is also possible that the entire second pins 522, 722 do not overlap the sub door 40 in the vertical direction.

Below, a process of opening the main door 30 and sub door 40 together will be described.

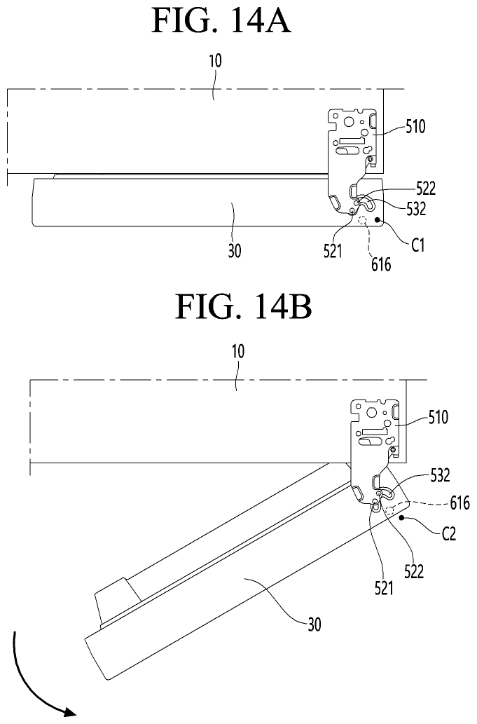

FIG. 14A is a drawing showing a state in which a main door and a sub door are closed. FIG. 14B is a drawing showing a state in which a main door is opened by a first angle.

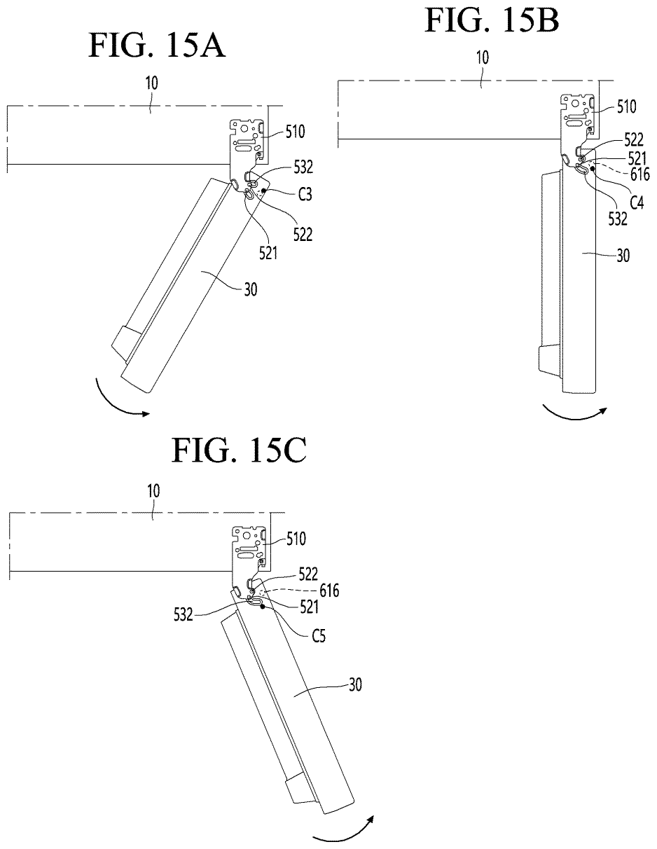

FIG. 15A is a drawing showing a state in which a main door is opened by a second angle greater than a first angle. FIG. 15B is a drawing showing a state in which a main door is opened by a third angle greater than a second angle. FIG. 15C is a drawing showing a state in which a main door is opened by a maximum opening angle.

In the present invention, when a refrigerator 1 is installed in the furniture cabinet P or is installed in the kitchen, an opening angle of the first door 21 needs to be increased without the first door 21 interfering with the furniture cabinet P during an opening process of the first door 21.

In the present embodiment, the opening angle of the first door 21 can be increased without the first door 21 interfering with the furniture cabinet P by the main hinge device 50 and 70.

For example, the main hinge device 50 and 70 may cause a rotation center of the main door 30 to move in at least a portion of the entire opening period of the main door 30. At this time, the rotation center may move in a direction away from one surface of the furniture cabinet P.

In the present embodiment, the rotation center (or virtual rotation center) of the main door 30 may move depending on a shape of the pin slot 532, 732.

Depending on a shape of the pin slot 532, 732, the rotation center of the main door 30 may move continuously or stepwise.

Referring to FIGS. 2 to 15, when the main door 30 and the sub door 40 are in a locked state, when the main door 30 is rotated, the main door 30 and the sub door 40 may be rotated together.

When the main door 30 and the sub door 40 are in an unlocked state by the locking device 370, the sub door 40 may be rotated in a state in which the main door 30 is closed.

During a rotation of the main door 30, the pin slot 532 and 732 moves with respect to the pin unit 520 and 720, so that relative positions of the pin unit 520 and 720 and the pin slot 732 and 732 may be changed.

If a curvature of the pin slot 532 and 732 is changed stepwise, the pin slot 532 and 732 may include a plurality of distinct paths. That is, the pin slot 532 and 732 may include a plurality of paths extending in different directions or having different curvatures.

A length of a portion of the plurality of paths may be different from a length of another portion of the plurality of paths.

Referring to FIG. 14A, when the main door 30 is closed and begins to be opened, the main door 30 may be rotated based on a first rotation center C1.

In this specification, the rotation center of the main door 30 may be a virtual rotation center of the main door 30.

The first rotation center C1 may be positioned at the main door 40. A portion of the hinge pin 616, 816 may be positioned farther from a front surface of the cabinet 10 than the first rotation center C1.

Referring to FIG. 14B, when the main door 30 is rotated by a first angle, the main door 30 may be rotated based on a second rotation center C2. That is, the rotation center of the main door 30 may move in an opening process of the main door 30 by the first angle. The second rotation center C2 may be positioned at an outside of the main door 30.

The second rotation center C2 may be positioned farther from the front surface of the cabinet 10 than the first rotation center C1. The second rotation center C2 may be positioned farther from the front surface of the cabinet 10 than the hinge pin 616 and 816.

Referring to FIG. 15A, when the main door 30 is rotated by a second angle, the main door 30 may be rotated based on a third rotation center C3. That is, the rotation center of the main door 30 may move in the opening process of the main door 30 by a second angle. The third rotation center C3 may be positioned at the main door 30.

The third rotation center C3 may be positioned closer to the front surface of the cabinet 10 than the second rotation center C2.

A portion of the hinge pin 616 and 816 may be positioned farther from the front surface of the cabinet 10 than the third rotation center C3.

Referring to FIG. 15B, when the main door 30 is rotated by a third angle, the main door 30 may be rotated based on a fourth rotation center C4. That is, the rotation center of the main door 30 may move in the closing process of the main door 30 by the third angle. The fourth rotation center C4 may be positioned at the main door 30.

The fourth rotation center C4 may be positioned farther from the front surface of the cabinet 10 than the hinge pin 616 and 816.

Referring to FIG. 15C, the main door 30 may be rotated based on a fifth rotation center C5 just before the main door 30 is opened by a maximum opening angle. The fifth rotation center C5 may be positioned at the main door 30.

The fifth rotation center C5 may be positioned farther from the front surface of the cabinet 10 than the fourth rotation center C4. The fifth rotation center C5 may be positioned farther from the front surface of the cabinet 10 than the hinge pin 616 and 816.

In this embodiment, during a portion of an entire opening period of the main door 30, the rotation center may move away from the front surface of the cabinet 10.

During another portion of the entire opening period of the main door 30, the rotation center may move toward the front surface of the cabinet 10.

During a portion of the entire opening period of the main door 30, the rotation center may move away from one surface of the furniture cabinet.

During another portion of the entire opening period of the main door 30, the rotation center may move toward one surface of the furniture cabinet.

During at least a portion of the entire opening period of the main door 30, the rotation center of the main door 30 may be positioned farther from the front surface of the cabinet 10 than the hinge pin 616 and 816 of the sub door 40.

Next, relative positions of the hinge pin 616, 816, the first pin 521, 721, and the second pin 522, 722 will be described.

When the main door 30 is closed, a distance between the hinge pin 616, 816 and the front surface 30a of the main door 30 may be less than a distance between the first pin 521, 721 and the front surface 30a of the main door 30.

When the main door 30 is closed, a distance between the hinge pin 616, 816 and the front surface 30a of the main door 30 may be less than a distance between the second pin 522, 722 and the front surface 30a of the main door 30.

When the main door 30 is closed, a distance between the hinge pin 616, 816 and the front surface 30a of the main door 30 may be less than a distance between the first end 532a of the pin slot 532, 732 and the front surface 30a of the main door 30.

When the main door 30 is closed, a distance between the hinge pin 616, 816 and the front surface 30a of the main door 30 may be less than the distance between the second end 532b of the pin slot 532, 732 and the front surface 30a of the main door 30.

When the main door 30 is closed, a distance between the hinge pin 616, 816 and the first side surface 30c of the main door 30 may be less than a distance between the first end 532a and the first side surface 30c of the main door 30.

When the main door 30 is closed, a distance between the hinge pin 616, 816 and the first side surface 30c of the main door 30 may be greater than a distance between the second end 532b and the first side surface 30c of the main door 30.

Next, a process of rotating the sub door 40 will be described.

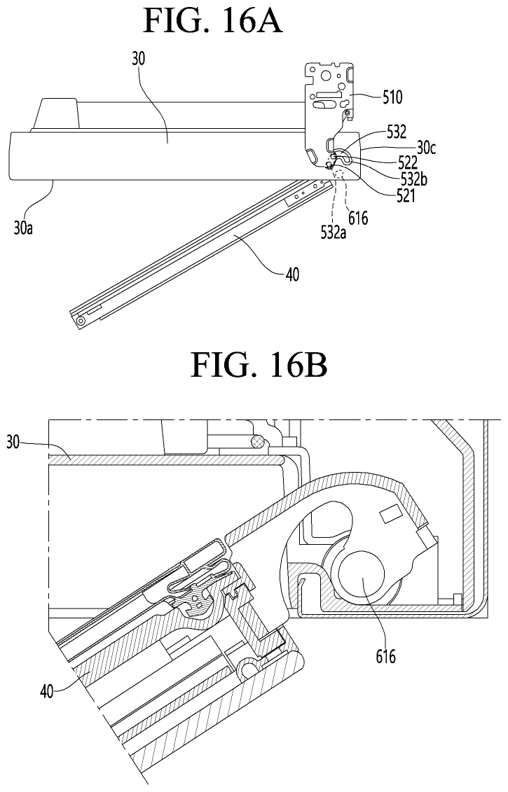

FIGS. 16A to 19B illustrate a rotation of a sub door in a state in which a main door is closed.

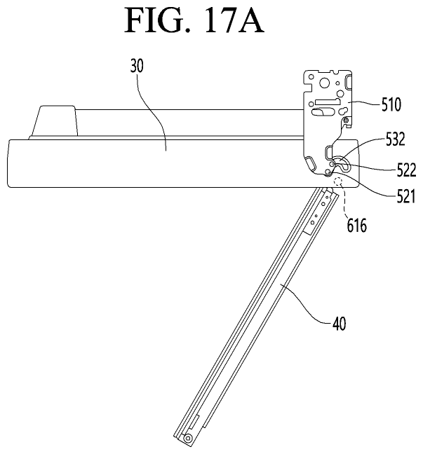

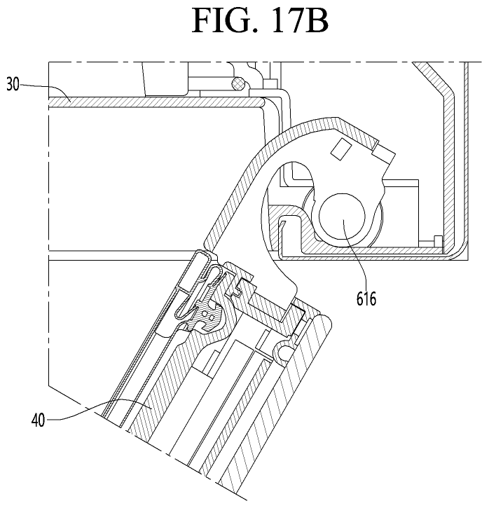

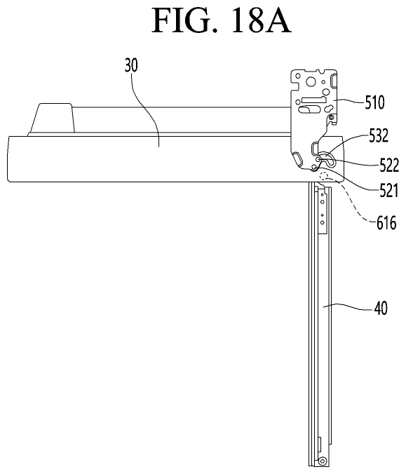

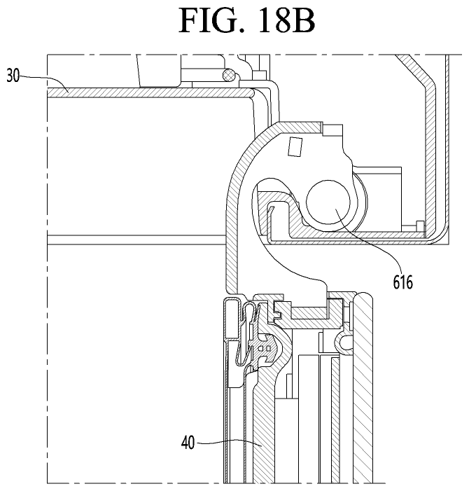

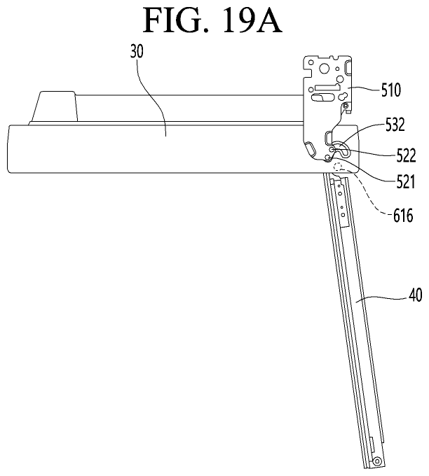

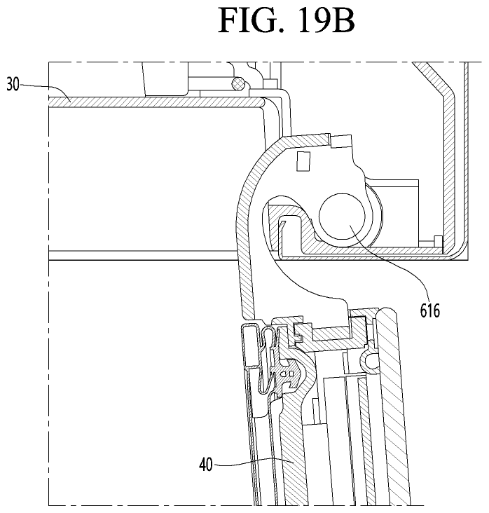

FIGS. 16A and 16B are drawings showing a state in which the sub door is rotated by a first angle while the main door is closed. FIGS. 17A and 17B are drawings showing a state in which the sub door is rotated by a second angle while the main door is closed. FIGS. 18A and 18B are drawings showing a state in which the sub door is rotated by a third angle while the main door is closed. FIGS. 19A and 19B are drawings showing a state in which the sub door is rotated by A maximum opening angle while the main door is closed.

Referring to FIGS. 16A to 19B, the sub door 40 may be rotated based on the hinge pin 616 and 816. During a rotation of the sub door 40, a position of the hinge pin 616 and 816 may be fixed.

The sub door 40 may be rotated without interfering with the main door 30 by the coupling portion 614 and 814, and even when the sub door 40 is opened by a maximum opening angle, interference with the furniture cabinet can be prevented because the hinge pin 616 and 816 is located at the main door 30.

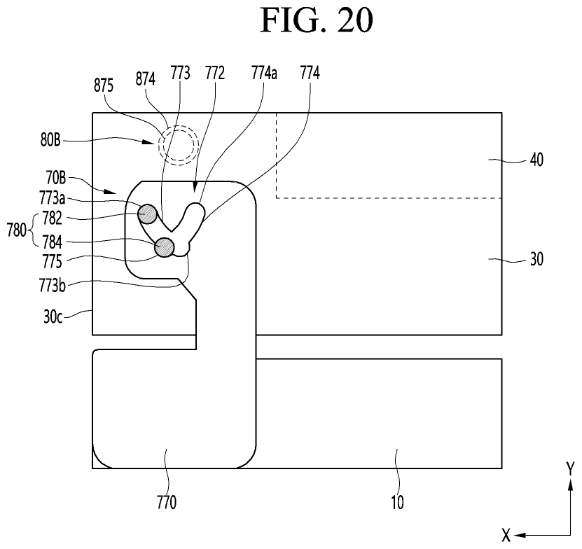

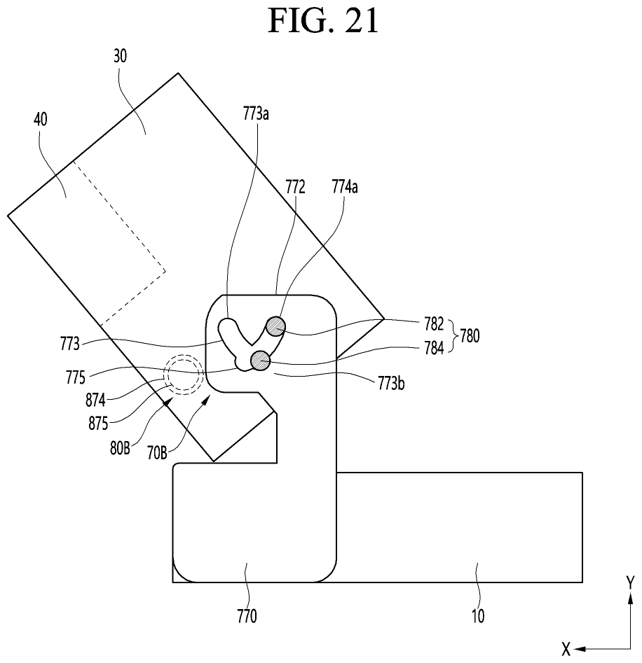

FIG. 20 is a plan view showing a first door according to a second embodiment. FIG. 21 is a view showing a state in which a main door is opened by a maximum opening angle according to a second embodiment.

This embodiment is identical to the first embodiment in other respects, except that there is a difference in positions of the first pin unit and the first pin slot. Therefore, only characteristic parts of this embodiment will be described below. The same drawing reference numerals will be used for the same components as the first embodiment.

Referring to FIGS. 20 and 21, a first door 21 of the present embodiment may include a main door 30 and a sub door 40.

In the present embodiment, the main door 30 may be rotated by a main hinge device 70B, and the sub door 40 may be rotated by a sub hinge device 80B.

The main hinge device 70B may include a hinge body 770 having a pin slot 772, and a pin unit 780.

The sub hinge device 80B may include a hinge pin 875 and a bushing 874. A structure of the sub hinge device 80B may be the same as a structure of the sub hinge device described in the first embodiment, and thus a detailed description thereof will be omitted.

The pin unit 780 may be, for example, coupled to an upper side of the main door 30 or formed integrally with the main door 30.

The pin unit 780 may include a first pin 782 and a second pin 784 that are spaced apart from each other.

The first pin 782 and the second pin 784 may be formed integrally with the main door 30. Alternatively, the pin unit 780 may include a plate supporting the first pin 782 and the second pin 784, and the plate may be coupled to the main door 30.

The first pin 782 and the second pin 784 may be spaced apart in a front-back direction (or Y-axis direction) of the refrigerator or in an arrangement direction of the cabinet 10 and the first door 21. In addition, the first pin 782 and the second pin 784 may also be spaced apart in an X-axis direction crossing the Y-axis direction.

The pin slot 772 may be a hole through which the first pin 782 and the second pin 784 pass, or a groove into which the first pin 782 and the second pin 784 are inserted.

The pin slot 772 may include a first slot portion 773. The first slot portion 773 may extend in a direction crossing the X-axis and the Y-axis. The first slot portion 773 may guide the first pin 782 during an opening and closing process of the main door 30. The first slot portion 773 may extend in a curved shape.

The pin slot 772 may further include a second slot portion 774 extending from the first slot portion 773. The second slot portion 774 may extend at a position spaced apart from both ends 773a and 773b of the first slot portion 773. The second slot portion 774 may guide the second pin 784 during the opening and closing process of the main door 30. The second slot portion 774 may extend in a curved shape.

The pin slot 772 may further include a third slot portion 775 extending from the first slot portion 773. The third slot portion 775 may be positioned at an opposite side of the second slot portion 774 in the first slot portion 773.

In a state in which the main door 30 is closed, the hinge pin 875 may be positioned closer to the front surface of the main door 30 than the first pin 782 and the second pin 784.

When the main door 30 is closed, at least a portion of the hinge pin 875 may be positioned farther from the first side surface 30c of the main door 30 than one or more of the first pin 782 and the second pin 784.

In a process of closing the main door 30, the first pin 782 may be in contact with or adjacent to the first end 773a, and the second pin 784 may be in contact with or adjacent to an end of the third slot portion 775.

In a process of opening the main door 30 to a maximum opening angle, the first pin 782 may be in contact with or adjacent to an end 774a of the second slot portion 774, and the second pin 784 may be in contact with or adjacent to the second end 773b of the first slot portion 773.

When the main door 30 is opened by a maximum opening angle, the hinge pin 875 may be positioned closer to the front surface of the cabinet 10 than the first pin 782 and the second pin 784.

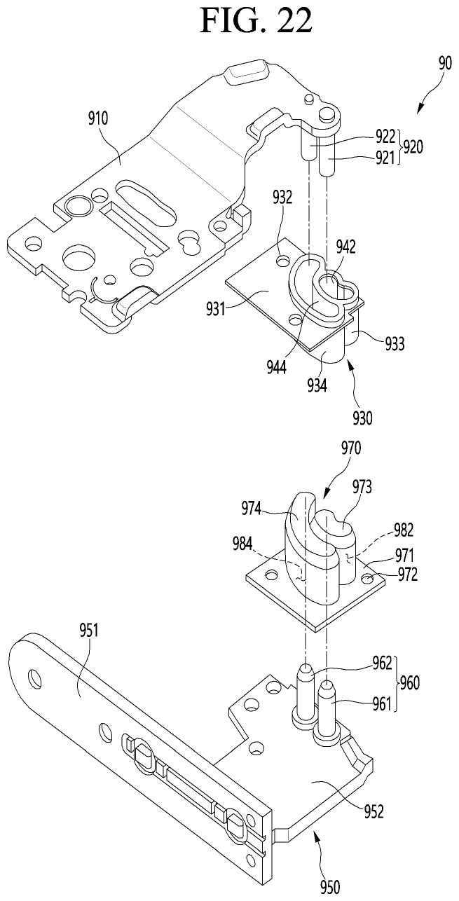

FIG. 22 is a perspective view showing a main hinge device according to a third embodiment.

This embodiment is identical to the first embodiment in other respects, except that it differs a shape of the guide member. Therefore, only characteristic parts of this embodiment will be described below.

Referring to FIG. 22, a main hinge device of the present embodiment may include an upper main hinge device 90 and a lower main hinge device 950.

The upper main hinge device 90 may include a first hinge body 910 and a first pin unit 920.

The first pin unit 920 may, for example, extend from the first hinge body 910 toward the main door 30. The first pin unit 920 may extend downward from the first hinge body 910.

The first pin unit 920 may include a first pin 921 and a second pin 922. The first pin 921 and the second pin 922 may be spaced apart from each other in the first hinge body 910.

A basic shape and function of the first pin 921 and the second pin 922 are the same as the first pin and the second pin of the first embodiment, so a detailed description thereof will be omitted.

The upper main hinge device 90 may include a first guide member 930. The first guide member 930 may be provided at the main door 30. The first guide member 930 may form a first pin slot.

The first pin slot may include a first slot 942 in which the first pin 921 is received, and a second slot 944 in which the second pin 922 is received. The first slot 942 and the second slot 944 may be separated from each other and spaced apart from each other.

The first guide member 930 may include an extension 931 coupled to the main door 30. A coupling hole 932 through which a coupling member passes may be formed in the extension 931. The coupling member may be coupled to the main door 30 by passing through the coupling hole 932.

The first guide member 930 may include a first body part 933 forming the first slot 942 and a second body part 934 forming the second slot 944. The first body part 933 and the second body part 934 may extend from the extension 931.

A lower main hinge device 950 of the present embodiment may include a second hinge body and a second pin unit 960.

The second hinge body may include, for example, a coupling portion 951 coupled to the cabinet 10 and an extension 952 extending from the coupling portion 951. The second pin unit 960 may be provided at the extension 952.

The second pin unit 960 may, for example, extend upward from the extension 952.

The second pin unit 960 may include a first pin 961 and a second pin 962. The first pin 961 and the second pin 962 may be spaced apart from each other in the extension 952.

The lower main hinge device 950 may further include a second guide member 970. The second guide member 970 may be provided at the main door 30.

The second guide member 970 may form a second pin slot.

The second pin slot may include a first slot 982 in which the first pin 961 is received, and a second slot 984 in which the second pin 962 is received. The first slot 982 and the second slot 984 may be spaced apart from each other.

The second guide member 970 may include an extension 971 coupled to the main door 30. A coupling hole 972 through which a coupling member passes may be formed in the extension 971. The coupling member may be coupled to the main door 30 by passing through the coupling hole 942.

The second guide member 970 may include a first body part 973 forming the first slot 982 and a second body part 974 forming the second slot 984. The first body part 973 and the second body part 974 may extend from the extension 971.

A rotation center of the main door 30 can also be moved by the upper main hinge device 90 and the lower main hinge device 950 of the present embodiment.

In the present embodiment, at least a portion of the hinge pin for a rotation center of the sub door 40 may be positioned closer to the front surface of the main door 30 than the first slot 982 and the second slot 984 when the main door 30 and the sub door 40 are closed.

At least a portion of the hinge pin for the rotation center of the sub door 40 may be positioned closer to the first side surface 30c of the main door 30 (see FIG. 20) than one or more of the first pins 921, 961 and the second pins 922, 962 when the main door 30 and the sub door 40 are closed.

In the present embodiment, when the main door 30 is closed, at least a portion of the first slot 942, 982 may be positioned closer to the first side surface 30c than the hinge pin 616, 816.

In the present embodiment, when the main door 30 is closed, at least a portion of the second slot 944, 984 may be positioned closer to the first side surface 30c than the hinge pin 616, 816.

In the present embodiment, positions of the first pin 921, 961 and the second pin 922, 962 may be changed to various positions, and accordingly, the first pin 921, 961 and the second pin 922, 962 may overlap or not overlap the hinge pin 616, 816 in the vertical direction.

What is claimed is:

1. A refrigerator comprising:
a cabinet having a storage space;
a main door configured to open and close at least a portion of the storage space;
a sub door received in a receiving portion of the main door and rotatably connected to the main door;
a main hinge device that allows the main door to rotate with respect to the cabinet; and
a sub hinge device that allows the sub door to rotate with respect to the main door,
wherein the main hinge device includes:
a main hinge body installed at the cabinet,
a pin unit provided at one of the main hinge body and the main door, and
a pin slot provided at another of the main hinge body and the main door and in which the pin unit is received,
wherein the sub hinge device includes:
a sub hinge body coupled to the sub door, and
a hinge pin extending from the sub hinge body and providing a rotation center of the sub door, and
wherein, during an opening process of the main door, relative positions of the pin slot and the pin unit vary and a rotation center of the main door moves.

2. The refrigerator of claim 1, wherein the pin unit includes a first pin and a second pin, and
wherein a distance between a portion of the hinge pin and a front surface of the main door is less than a distance between the first pin and the front surface of the main door.

3. The refrigerator of claim 2, wherein a distance between a portion of the hinge pin and the front surface of the main door is less than a distance between the second pin and the front surface of the main door.

4. The refrigerator of claim 1, wherein the pin unit includes a first pin and a second pin,
wherein the pin slot includes a first end in contact with or adjacent to the first pin when the main door is closed, and a second end in contact with or adjacent to the second pin when the main door is opened by a maximum opening angle, and
wherein, when the main door is closed, a distance between a portion of the hinge pin and a front surface of the main door is less than a distance between the first end and the front surface of the main door.

5. The refrigerator of claim 4, wherein, when the main door is closed, a distance between a portion of the hinge pin and the front surface of the main door is less than a distance between the second end and the front surface of the main door.

6. The refrigerator of claim 4, wherein a side surface adjacent to the main hinge device among both side surfaces of the main door is referred to as a first side surface, and
wherein a distance between a portion of the hinge pin and the first side surface is less than a distance between the first end and the first side surface.

7. The refrigerator of claim 6,
wherein when the main door is closed, a distance between the second end and the first side surface is less than a distance between a portion of the hinge pin and the first side surface.

8. The refrigerator of claim 1, wherein the pin unit includes a first pin and a second pin,
wherein the pin slot includes a first slot for receiving the first pin and a second slot for receiving the second pin, and
wherein when the main door is closed, at least a portion of the hinge pin is positioned closer to a front surface of the main door than the first slot or the second slot.

9. The refrigerator of claim 8, wherein a side surface adjacent to the main hinge device among both side surfaces of the main door is referred to as a first side surface, and
wherein, when the main door is closed, at least a portion of the first slot is positioned closer to the first side surface than the hinge pin, or at least a portion of the second slot is positioned closer to the first side surface than the hinge pin.

10. The refrigerator of claim 1, wherein, when the main door and the sub door are closed, at least a portion of the pin slot overlaps the sub door in a vertical direction.

11. The refrigerator of claim 10, wherein the pin unit includes a first pin and a second pin received in the pin slot,
wherein the pin slot includes a first end in contact with or adjacent to the first pin when the main door is closed, and a second end in contact with or adjacent to the second pin when the main door is opened by a maximum opening angle, and
wherein the first end overlaps the sub door in the vertical direction.

12. The refrigerator of claim 11, wherein the second end does not overlap the sub door in the vertical direction.

13. The refrigerator of claim 11, wherein, when the main door and the sub door are closed, a portion of the pin slot is positioned farther from a front surface of the main door than the sub door.

14. The refrigerator of claim 11, wherein at least a portion of the first pin overlaps the sub door in the vertical direction, and the second pin overlaps or does not overlap the sub door in the vertical direction.

15. The refrigerator of claim 1, wherein the main door includes a hinge receiving portion that forms a space for receiving the sub hinge device, and
wherein the hinge receiving portion is provided with a pin coupling portion to which the hinge pin is coupled.

16. A refrigerator comprising:
a cabinet having a storage space;
a main door configured to open and close at least a portion of the storage space;
a sub door received in a receiving portion of the main door and rotatably connected to the main door;
a main hinge device that allows the main door to rotate with respect to the cabinet; and
a sub hinge device that allows the sub door to rotate with respect to the main door,
wherein the main hinge device includes:
a main hinge body installed at the cabinet,
a pin unit provided at one of the main hinge body and the main door and having a first pin and a second pin, and
a pin slot provided at another of the main hinge body and the main door and receiving the pin unit,
wherein the sub hinge device includes:
a sub hinge body coupled to the sub door, and
a hinge pin extending from the sub hinge body and providing a rotation center of the sub door, and
wherein a centerline of the first pin, a centerline of the second pin, and a centerline of the hinge pin are spaced apart from one another.

17. The refrigerator of claim 16, wherein at least a portion of the hinge pin is positioned closer to a front surface of the main door than the first pin and the second pin.

18. The refrigerator of claim 16, wherein a side surface adjacent to the main hinge device among both side surfaces of the main door is referred to as a first side surface, and
wherein at least a portion of the hinge pin is positioned closer to the first side surface than at least one of the first pin or the second pin.

19. The refrigerator of claim 16, wherein at least a portion of the hinge pin is positioned closer to a front surface of the main door than the pin slot.

20. The refrigerator of claim 16, wherein a side surface adjacent to the main hinge device among both side surfaces of the main door is referred to as a first side surface, and
wherein at least a portion of the pin slot is positioned closer to the first side surface than the hinge pin.
